(19) United States
(12) Patent Application Publication
(10) Pub. No.: US 2024/0328236 A1
(43) Pub. Date: Oct. 3, 2024

(54) ELECTRIC SWITCH AND METHOD FOR MANUFACTURE

(71) Applicant: International Automotive Components Group NA, Inc., Southfield, MI (US)

(72) Inventors: SUNG-UK KIM, Grafing (DE); Carter Scott CANNON, Munich (DE)

(21) Appl. No.: 18/623,295

(22) Filed: Apr. 1, 2024

Related U.S. Application Data
(60) Provisional application No. 63/493,072, filed on Mar. 30, 2023.

(51) Int. Cl. E05F 15/75; B60J 5/04

(52) U.S. Cl. CPC E05F 15/75; B60J 5/0413; E05Y 2400/445

(57) ABSTRACT

An electric switch for a vehicle that is configured to reduce or avoid inadvertent activation of one or a plurality of selected vehicle operations, such as raising of a vehicle window. One or a plurality such electric switches may therefore be present at various locations within the interior trim components of a vehicle.

### CROSS-REFERENCE TO RELATED APPLICATION

This application claims the benefit of U.S. provisional patent application Ser. No. 63/493,072, filed Mar. 30, 2023, the entire disclosure of which is incorporated herein by reference.

### TECHNICAL FIELD

The present disclosure relates generally to an electric switch for a vehicle that is configured to reduce or avoid inadvertent activation and raising of, for example, the window. One or a plurality of such electric switches may be present in a vehicle trim component such as a vehicle door panel.

### BACKGROUND

Many vehicles have electric windows or other trim components that open and close correspond to the press/pull of a mechanical switch. Typically, the switch will have multiple positions: express up, up, neutral, down, and express down. Generally, the neutral position corresponds to a stationary window position and the up and down positions correspond to one opening/closing speed of the corresponding window. The express up and down positions are traditionally engaged when the mechanical switch is displaced beyond the respective up and down positions, which instruct the window to fully open or close.

### SUMMARY

An electric switch comprising a horizontally disposed upper wall portion, horizontally disposed lower wall portion, and two vertically disposed sidewalls collectively defining an opening wherein one of said vertically disposed sidewalls intersects with said horizontally disposed upper wall portion at an angle α of less than 90°. The switch includes a sensor present on said horizontally disposed upper wall portion wherein a force applied to said sensor foil on said horizontally disposed upper wall portion transmits a signal to control one or more selected vehicle operations. The switch also includes a sensor present on said vertically disposed sidewall that intersects with said horizontally disposed upper wall portion at an angle α of less than 90°, wherein a force applied to said sensor foil on said vertically disposed sidewall transmits a signal to control one or more selected vehicle operations.

In method form, the present invention relates to method of forming an electric switch comprising supplying a substrate, sensor and coverstock and compression molding said substrate, sensor and coverstock and providing an electric switch having a coverstock overlying a horizontally disposed upper wall portion, horizontally disposed lower wall portion, and two vertically disposed sidewalls collectively defining an opening wherein one of said vertically disposed sidewalls intersects with said horizontally disposed upper wall portion at an angle α of less than 90°. The formed switch also includes a sensor present on said horizontally disposed upper wall portion wherein a force applied to said sensor foil on said horizontally disposed upper wall portion transmits a signal to control one or more selected vehicle operations. The formed switch also includes a sensor present on said vertically disposed sidewall that intersects with said horizontally disposed upper wall portion at an angle α of less than 90°, wherein a force applied to said sensor foil on said vertically disposed sidewall transmits a signal to control one or more selected vehicle operations.

### BRIEF DESCRIPTION OF THE DRAWINGS

Various features and advantages of the present invention will be better understood by reading the following detailed description, taken together with the drawings, wherein:

FIG. 1 is a cross-sectional view of one preferred embodiment of the electrical switch herein.

FIG. 2 is a cross-sectional view of another preferred embodiment of the electrical switch herein as provided by the vehicle door substrate.

FIG. 3 is a cross-sectional view of another preferred embodiment of the electrical switch herein.

FIG. 4 illustrates the individual components of a preferred electrical switch herein that offers ease of assembly.

FIG. 5A illustrates a mold core portion and mold cavity for formation of a preferred electrical switch herein.

FIG. 5B illustrates the mold in FIG. 5A in the closed position.

FIG. 5C illustrates the mold in FIG. 5B now in the open position.

FIG. 6A illustrates the electrical switch positioned horizontally in a vehicle as in a vehicle door panel.

FIG. 6B illustrates the electrical switch herein as may be positioned in a vehicle headliner.

FIG. 6C illustrates the electrical switch herein as may be positioned vertically in the vehicle as in a vehicle sidewall panel.

### DESCRIPTION OF PREFERRED EMBODIMENTS

The present disclosure relates to an electric switch that reduces or avoids inadvertent activation, such as raising of the vehicle window. The switch is preferably configured to be coupled to the door of a vehicle, but may be positioned at other locations within the vehicle interior. For example, the switch may be positioned on a vehicle floor console, lower/upper vehicle storage bin, overhead storage trim panel, rear storage (trunk), and front storage (frunk). As explained further herein, the switch can be oriented in a variety of configurations within the vehicle. Reference to vehicle herein also contemplates automobiles, trucks, trains, bus and/or aircraft.

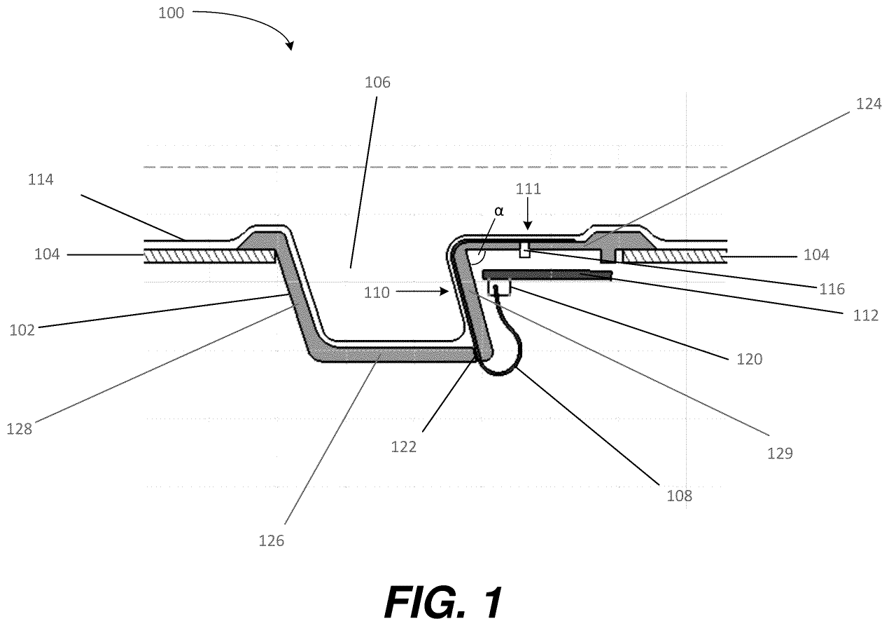

FIG. 1 shows a side view of one preferred embodiment of a window switch 100 for a window (not shown) wherein a switch assembly 102 is preferably disposed within a support substrate 104 of the vehicle. The present invention contemplates that one or a plurality of such window switches may be present in, e.g., a vehicle armrest.

The switch assembly 102 defines an opening 106. The switch assembly has a generally horizontal disposed upper wall portion 124, generally horizontal disposed lower wall portion 126, and two generally vertical disposed sidewalls 128 and 129. Sidewall 128 is positioned relatively forward in the vehicle and sidewall 129 is position relatively rearward in the vehicle. A sensor 108 that generates an electric signal upon application of pressure, such as a preferred pressure sensor foil is disposed along the sidewall 129 defining an input region 110. The preferred pressure sensor foil is attached to electrical connection 120. The pressure sensor foil may preferably be protected by a skin material 114. It may therefore be appreciated that the sensor 108 herein that provides electrical output in response to pressure or touch may comprise printed electronics, including but not limited to a circuit with sensing areas for capacitance, touch, or force-touch type activation.

The input region 110 in sidewall 129 allows the user to press and apply a force against the sensor 108 at input region 110. This then transmits a signal to printed circuit board (PCB) 112 through connector 120 which then, through other more typical electro-mechanical operations within the vehicle, results in, e.g., raising of the vehicle window. However, it may result in the triggering of one or more of selected operations in the vehicle. Accordingly, such vehicle operations may include closing of a vehicle window, locking a vehicle door, closing of a vehicle sunroof, etc. As can be initially seen in FIG. 1, vertically disposed sidewall 129 preferably intersects with horizontally disposed upper wall portion 124 at an angle α of less than 90°. More preferably, the angle α has a value herein in the range of 89° to 70°, including all individual values and increments therein. Accordingly, the angle α may have a value of 89°, 88°, 87°, 86°, 85°, 84°, 83°, 82°, 81°, 80°, 79°, 78°, 77°, 76°, 75°, 74°, 73°, 72°, 71° and 70°.

It may therefore be appreciated that by placement of the input region 110 on sidewall 129, that intersects with horizontally configured upper wall portion 124 at the angle α of less than 90°, one will now reduce or avoid inadvertent activation and raising of the window. That is, a user must, contrary to natural ergonomic behavior, place their finger into the opening 106 and deliberately configure or reposition their finger to engage with input region 110 and pressure sensing foil 108, to activate a “window-up” signal to printed circuit board 112. It can therefore be appreciated that if the user is just resting their finger within opening 106, and with the vertically disposed sidewall effectively tilted away from the user's finger, the window switch 110 now provides for the ability to reduce or avoid inadvertent activation and raising (closing) of the window.

This then improves the safety operation of window switch 110 by reducing or eliminating the possibility of inadvertent closing of the window. In addition, it may be appreciated, that with children and pets present in the vehicle, should they then inadvertently place a finger or paw within depression 106, there is now a reduced possibility of closing the window and pinching and injuring a finger or paw within the window frame. However, in the broad context of the present invention, and as noted, this safety operation benefit of the electric switch design herein is applicable for control of other functions within the vehicle.

As also illustrated in FIG. 1, the sensing foil 108 also preferably provides an input region 111 that is disposed on the generally horizontally upper wall portion 124. Upon pressing by the user at input region 111, the sensing foil 108 can then transmit a signal to the preferred printed circuit board (PCB) 112 which then, through other more typical electro-mechanical operations, results in lowering of the vehicle window. However, in the broad context of the present invention, the signal generated by the user at input region 111 may result in control of one or more of other selected vehicle operations, such as opening the vehicle window, opening a sunroof, etc.

As further illustrated in FIG. 1, the sensing foil may preferably pass-through an opening 122 as between the generally horizontal lower wall portion 126 and sidewall 129. In addition, it is preferable to include an opening in generally horizontal wall portion 124 for insertion of a light indicator 116.

The switch assembly 102 is also preferably configured to be disposed within a vehicle door panel substrate 104 wherein the switch assembly 102 is made flush or relatively flush with the substrate 104. The switch assembly 102 may be then be easily removed from the armrest of the vehicle for access and repair of the window switch 100 along with other components embedded in the armrest.

As shown in the embodiment of FIG. 1, a skin 114 is preferably disposed along a portion of substrate 104, along sidewalls 128 and 129 and then along the generally horizontal upper wall portion 124. Accordingly, the skin 114 may act as a protecting surface for the sensor foil 108. The skin or coverstock 114 may preferably be a polymeric material, leather and/or textile material. All or a portion of the skin 114 may preferably be translucent such that one or more visual indicators 116 (e.g. graphics or icons) may illuminate through the portion of the skin 114 to facilitate viewing by the user. The skin 114 may also include tactile features such as raised portions or ridges that may correspond to visual indicator 116 to inform the user of the input portions 110 and/or 111. The skin 114 may therefore preferably include one or more visual or textured patterns such as regular or irregular repeating designs, a repeating diamond pattern, a faux leather pattern, an artificial wood gran, etc.

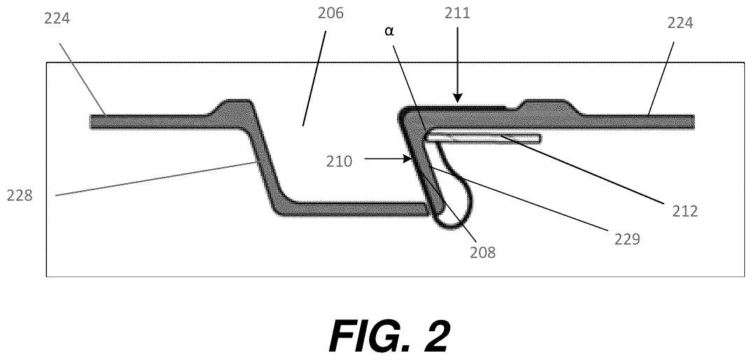

FIG. 2 depicts an embodiment wherein the vehicle door substrate itself is configured to define an opening 206. Reference to a vehicle door substrate is reference to the interior trim frame that typically attaches to the metal door of the vehicle and which typically includes an armrest substrate. Opening 206 therefore again includes a generally horizontal upper substrate wall portion 224, generally horizontal lower substrate wall portion 226 and substrate sidewalls 228 and 229. Substrate sidewall 228 is positioned forward in the vehicle and substrate sidewall 229 is positioned aft in the vehicle. A pressure sensor foil 208 is disposed along the sidewall 229 within depression 206, defining an input region 210. Similar to the description provided for FIG. 1, the input region 210 in sidewall 229 allows the user to press against the sensor foil 208 to transmit a signal to the printed circuit board (PCB) 212 which then through typical electro-mechanical operations in the vehicle results in a raising of the vehicle window.

As can be seen in FIG. 2, vertically configured vehicle substrate sidewall 229 preferably intersects with horizontal configured upper vehicle substrate wall portion 224 at an angle α of less than 90°. More preferably, the angle α has a value herein in the range of 89° to 70°, including all individual values and increments therein. Accordingly, the angle α in FIG. 2 may have a value of 89°, 88°, 87°, 86°, 85°, 84°, 83°, 82°, 81°, 80°, 79°, 78°, 77°, 76°, 75°, 74°, 73°, 72°, 71° and 70°. As also illustrated in FIG. 2, the sensing foil 208 preferably provide an input region 211 that is disposed on the generally horizontal substrate upper wall portion 224. Upon pressing by the user at input region 211, the sensing foil 208 can then transmit a signal to the printed circuit board (PCB) 212, which again, through other more typical electro-mechanical operations, preferably results in lowering of the vehicle window.

It may again be appreciated that by placement of the input region 210 on substrate sidewall 229, the intersection with horizontally configured substrate upper wall portion 224 at the angle α of less than 90°, one will again reduce or avoid inadvertent activation and raising of the window, for all of the same rationale described in the case of FIG. 1.

Expanding upon the above, the portion of the vehicle door substrate illustrated in FIG. 2 may be disposed within a portion of the vehicle door or may make up an interior door panel. The substrate 224 may be manufactured with a series of one or more openings 206 such that one or more input portions 210 may be disposed upon or within the openings 206. The substrate 224 of may be comprised of one or more materials, including metal, plastic, polymer, wood, etc. The substrate 224 may preferably be made of a moldable plastic such as thermoplastic resin, including, e.g., ABS, PC-ABS, PVC, etc. The plastic substrate 224 may be formed by a plastics molding manufacturing method such as injection molding.

Sensors (108, 208) preferably include electrical sensors that generate a signal upon application of a force. The sensors are preferably a flexible material, which may be conductive, semi-conductive, or resistive. In some embodiments, the surface of the sensor may be a layered material comprising one conductive layer between two resistive layers or one or more of the resistive layers may be etched away to create wire channels. Moreover, the surface of the sensor may comprise a resistive material where wires are printed on top of the surface using additive manufacturing methods. In some embodiments, the wires may be printed onto the surface of the sensor by a CNC machine configured with a conductive material printer head.

The sensor foils at input portions 110, 111, 210 or 211 may be more preferably configured as follows. The sensor foils may be provided and programmed in conjunction with printed circuit boards 112 or 212, to independently measure the force applied. For example, the sensor foils at input portions 110, 111, 210 or 211 may be preferably configured so that upon application of a minimum force, such as a force of 2 Newtons, the window will be repositioned to travel up or down, as selected by the user. In addition, the user may preferably be provided with haptic feedback from an integrated haptic actuator. In addition, if the applied force exceeds another selected force threshold, such as 4 Newtons, the window may then be programmed to enter into an express up or down condition. An express up or express down condition is reference to the feature that the user, after applying a force that exceeds the selected force threshold, will observe the window completely raising of lowering, without the need to continue to apply any further force at input portions 110, 111, 210 or 211.

In addition, the sensors foil at input portions 110, 111, 210 or 211 may be more preferably configured to provide a user variable window opening or closing speed. For example, depending upon the input force, the open or closing of the window is preferably programmed to proceed to open (lower) at a speed in the range of 50 mm/second to 200 mm/second. In a related manner, depending upon the input force, the closing (raising) of the window may now proceed at a speed in the range of 50 mm/second to 100 mm/second. Moreover, the maximum closing speed of the window may therefore be set not to exceed 100 mm/second.

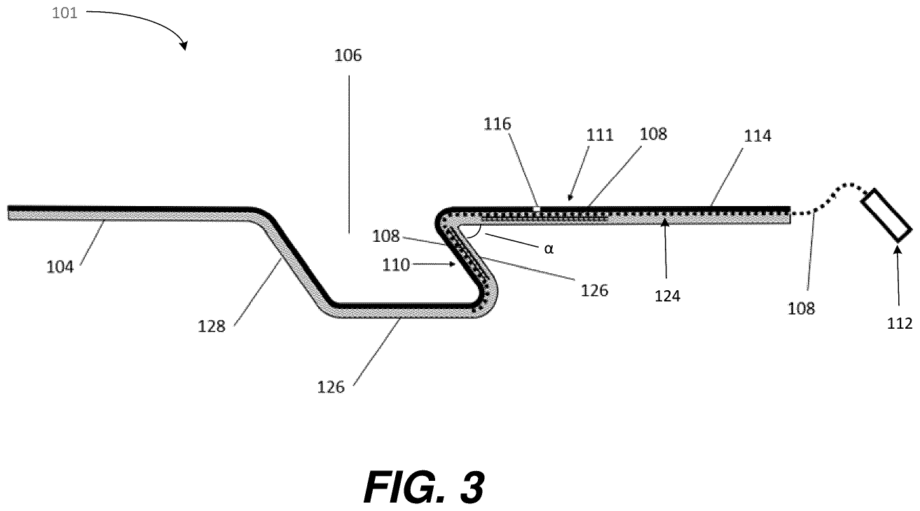

Attention is directed to FIG. 3 which illustrates another preferred embodiment of the present invention which offers additional advantages in the method of assembly. This preferred version of the switch 101 as illustrated again includes an opening 106 and a sidewall 126 that similarly intersects with upper wall portion 124 at an angle α of less than 90°, more preferably the angle α again has a value herein in the range of 89° to 70°, including all individual values and increments therein. This particular configuration also relies upon a sensor 108. However, as may be appreciated, in this embodiment, there is no need for opening 124 to connect the sensor to, e.g., a printed circuit board 112. Namely, as can be observed, the sensor 108 is preferably located between the support structure 104 and upper skin material 114 and connects at one end of the switch 100 to a preferred printed circuit board 112, 212. It may therefore be appreciated that the switch 101 illustrated in FIG. 3 may find a number of applications, including but not limited to placement in the vehicle door trim to provide for window control, a door release handle opener, fuel/charger cover opener, hood/trunk release, vehicle load/leveller, or other seamlessly integrated function and feature. It should also be appreciated that the switch in FIG. 3 may be viewed as a stand-alone part for assembly to an interior component (e.g., switch 101, bezel, trim) or integral to an interior trim component (molded, inserted or laminated to an interior trim component).

The switch 101 may also find applications in the (a) instrument panel to release a glove boor dox or tray table; (b) instrument panel center stack and center floor console for control of the parking brake, window control or emergency or serve as an emergency warning switch; (c) sidewall trim for 2^{nd}/3^{rd} row seat fold control, load floor electronic release and open control, or electronic storage bin release); and (d) seating trim (electronic seat adjust controls or seatback trim table release).

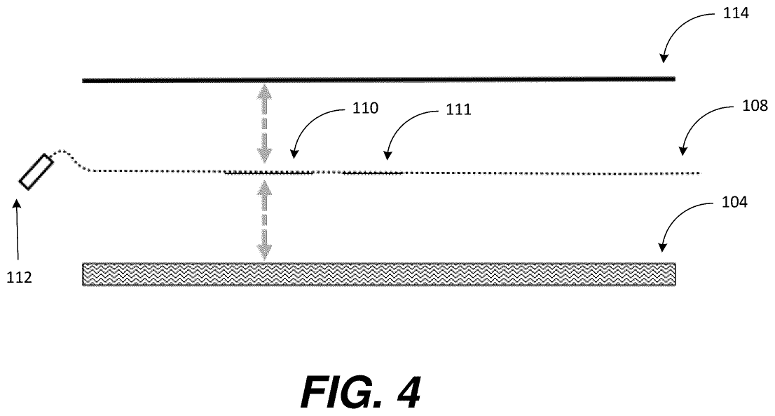

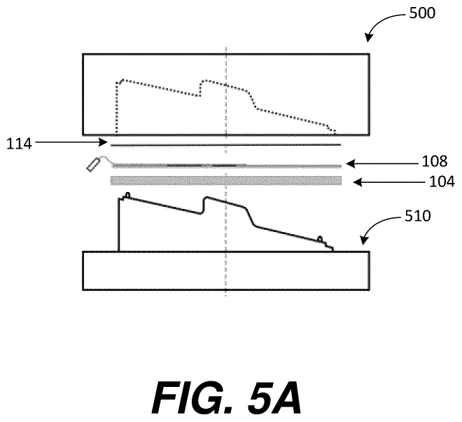

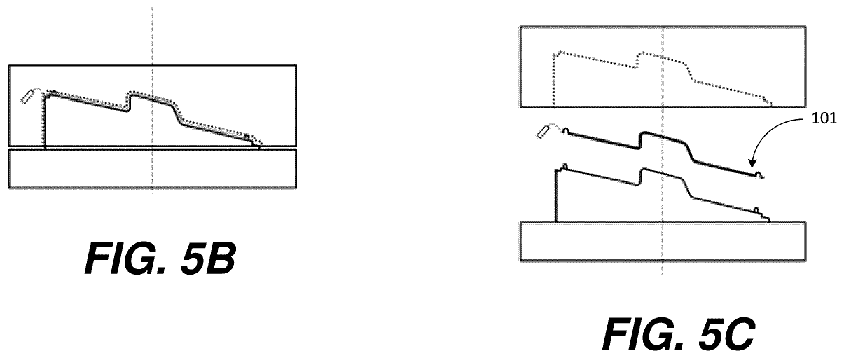

Attention is next directed to FIG. 4 which shows individual components of switch 101 illustrated in FIG. 3, prior to assembly. As can be seen, the individual components are identified as substrate 104, sensor 108 and coverstock 114. It is worth noting that substrate 104 may preferably comprise thermoplastic sheet material, natural fiber, or composite panels such as glass or synthetic fiber-filled polymeric resins or natural fiber filled polymeric resins. As can be appreciated, the substrate 104, sensor 108 and coverstock 114 may then be compression molded as shown in FIGS. 5A, 5B and 5C. As shown in FIG. 5A the mold includes a core portion 510 that includes the configuration 512 that shapes the features of switch 100 described herein. The substrate 104, sensor 108 and coverstock are positioned between the mold core portion 510 and mold cavity 500. The mold is then closed (FIG. 5B) and upon opening (FIG. 5C) the switch 101 illustrated in FIG. 3 is produced.

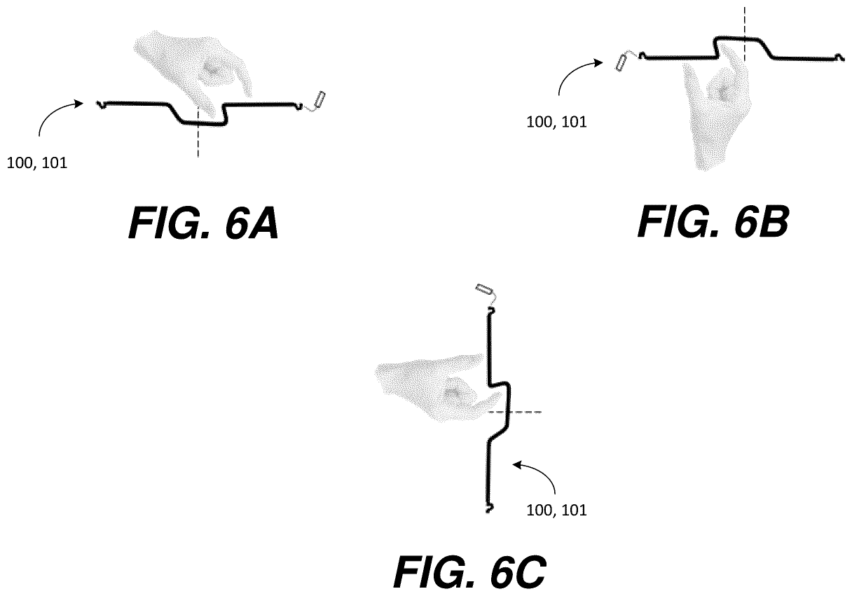

FIGS. 6A, 6B and 6C illustrate how the switch herein 100, 101 may preferably be positioned in a given vehicle. As shown in FIG. 6A, the switch 100, 101 may be positioned horizontally, as in a vehicle door trim component. As shown in FIG. 6B, the window switch 100, 101 may be positioned as shown in a headliner. Finally, as shown in FIG. 6C, the window switch 100, 101 may be positioned vertically as shown in, e.g., a vehicle sidewall trim panel.

While there has now been described as the preferred embodiments of the invention, those skilled in the art will recognize that other modifications may be made with departing from the more general scope of the invention and the invention should be therefore be limited to the preferred embodiments and/or specific examples disclosed herein.

1. An electric switch comprising:
a. a horizontally disposed upper wall portion, horizontally disposed lower wall portion, and two vertically disposed sidewalls collectively defining an opening wherein one of said vertically disposed sidewalls intersects with said horizontally disposed upper wall portion at an angle α of less than 90°;
b. a sensor present on said horizontally disposed upper wall portion wherein a force applied to said sensor foil on said horizontally disposed upper wall portion transmits a signal to control one or more selected vehicle operations;
c. a sensor present on said vertically disposed sidewall that intersects with said horizontally disposed upper wall portion at an angle α of less than 90°, wherein a force applied to said sensor foil on said vertically disposed sidewall transmits a signal to control one or more selected vehicle operations.

2. The electric switch of claim 1 wherein said vertically disposed sidewalls intersects with said horizontally disposed upper wall portion at an angle α of 89° to 70°.

3. The electric switch of claim 1 wherein a skin covering is disposed on said sensor.

4. The electric switch of claim 1 wherein said horizontally disposed upper wall portion, said horizontally disposed lower wall portion and said two vertically disposed sidewalls, are part of a vehicle door panel substrate.

5. The electric switch of claim 1 wherein a minimum force applied to said sensor on said horizontally disposed upper wall portion results in lowering of a vehicle window.

6. The electric switch of claim 5 wherein said minimum force is 2 Newtons.

7. The electric switch of claim 1 wherein a minimum force applied to said sensor on said vertically disposed sidewall that intersect with said horizontally disposed upper wall portion at an angle α of less than 90°, results in raising of a vehicle window.

8. The electric switch of claim 7 wherein said minimum force is 2 Newtons.

9. The electric switch of claim 1 wherein a selected force applied to said sensor located on said horizontally disposed upper wall portion results in a vehicle window undergoing an express down condition.

10. The electric switch of claim 1 wherein a selected force applied to said sensor located on said vertically disposed sidewall that intersect with said horizontally disposed upper wall portion at an angle α of less than 90°, results in a vehicle window undergoing an express up condition.

11. The electric switch of claim 1 wherein, depending upon the input force applied to the sensor on said horizontally disposed upper wall portion, a vehicle window will lower at a speed in the range of 50 mm/second to 200 mm/second.

12. The electric switch of claim 1 wherein, depending upon the input force applied to the sensor on said sensor foil on said vertically disposed sidewall that intersects with said horizontally disposed upper wall portion at an angle α of less than 90°, a vehicle window will raise at a speed in the range of 50 mm/second to 100 mm/second.

13. A vehicle door panel comprising one or a plurality of electric window switches for raising or lowering of a vehicle window, said electric window switch comprising:
a. a horizontally disposed upper wall portion, horizontally disposed lower wall portion, and two vertically disposed sidewalls collectively defining an opening wherein one of said vertically disposed sidewalls intersects with said horizontally disposed upper wall portion at an angle α of less than 90°;
b. a sensor present on said horizontally disposed upper wall portion wherein a force applied to said sensor on said horizontally disposed upper wall portion transmits a signal that results in lowering of said vehicle window;
c. a sensor present on said vertically disposed sidewall that intersects with said horizontally disposed upper wall portion at an angle α of less than 90°, wherein a force applied to said sensor on said vertically disposed sidewall transmits a signal that results in raising of said vehicle window.

14. A method of forming an electric switch comprising:
a. supplying a substrate, sensor and coverstock;
b. compression molding a substrate, sensor and coverstock and providing an electric switch having:
i. a coverstock overlying a horizontally disposed upper wall portion, horizontally disposed lower wall portion, and two vertically disposed sidewalls collectively defining an opening wherein one of said vertically disposed sidewalls intersects with said horizontally disposed upper wall portion at an angle α of less than 90°;
ii. a sensor present on said horizontally disposed upper wall portion wherein a force applied to said sensor foil on said horizontally disposed upper wall portion transmits a signal to control one or more selected vehicle operations; and
iii. a sensor present on said vertically disposed sidewall that intersects with said horizontally disposed upper wall portion at an angle α of less than 90°, wherein a force applied to said sensor foil on said vertically disposed sidewall transmits a signal to control one or more selected vehicle operations.

15. The method of claim 14 wherein said electric switch is positioned in a vehicle door panel.

16. The method of claim 14 wherein said electric switch is positioned in a vehicle floor console.

17. The method of claim 14 wherein said electric switch is positioned in a vehicle headliner.
